(19) United States
(12) Patent Application Publication
(10) Pub. No.: US 2004/0203897 A1
(43) Pub. Date: Oct. 14, 2004

(54) System and method for precise navigation in testing wireless communication networks

(75) Inventor: Steve Rogers, Irvine, CA (US)

Correspondence Address: Pillsbury Winthrop LLP, Intellectual Property Group, Suite 2800, 725 South Figueroa Street, Los Angeles, CA, 90017-5406, US

(73) Assignee: COMARCO WIRELESS TECHNOLOGIES, Irvine, CA

(21) Appl. No.: 10/321,112

(22) Filed: Dec. 17, 2002

(51) Int. Cl. H04Q 7/20

(52) U.S. Cl. 455/456.1; 455/446

(57) ABSTRACT

The invention relates to a system and method for collecting and analyzing data of a wireless communication network including “micro” or “pico” wireless networks. The system collects wireless network performance data utilizing a monitoring device, correlates this information with the monitoring device's location and transmits this time-correlated information to a display device. The system tracks the monitoring device in real-time and provides precise location information of the monitoring device. The system has a built-in self-correction mechanism in a navigational module to verify a test operator's location. In addition, the system also includes an analysis device for post-test processing of the collected cellular radiotelephone network's performance information. The system is portable with long-lasting battery power.

### FIELD OF THE INVENTION

This invention relates to testing of wireless communication networks, including the testing of in-building systems.

### BACKGROUND OF THE INVENTION

Recently, the demographics of cellular radiotelephone users have changed. The user base for cellular products has moved from mainly a vehicle-oriented subscriber base to a much wider pedestrian audience. In addition, the popularity of “one rate” plans has driven the usage of cellular telephony out of the secondary communications market and into the area of the subscriber's primary phone. Cellular coverage must, therefore, be extended to indoor meeting places (such as malls, airports, office buildings, apartment buildings, hospitals and other indoor sites) where users desire to place and receive telephone calls. The larger cellular network is referred to as the “macro” cellular network while a cellular network smaller in geography and possibly located inside a structure is referred to as a “micro” or “pico” cellular network.

The users' needs are driving an “any time, anywhere” connectivity requirement which makes in-building coverage a high-priority for cellular carriers. In the future, in-building coverage will become more important because Third Generation (3G) cellular systems carrying data will be deployed inside existing structures. In order to meet this “any time, anywhere” connectivity requirement, cellular radiotelephone service providers must be able to determine network coverage and network operational performance at all positions within the network, including inside buildings and structures.

In traditional mobile phone networks, adequate network coverage is measured utilizing many different methods.

For macro cells, adequate network coverage has been monitored through the performance of drive tests. At various points throughout the network, the personnel place and/or receive telephone calls over the cellular network. An operator drives throughout the network to conduct and record call quality checks. The operator uses mobile calling devices modified with specialized software to monitor parameters of the cellular radio environment. The operator attaches the modified mobile calling device to a personal computer via a standard RS-232, Ethernet, or Universal Serial Bus (USB) serial connection. A global positioning system (GPS) receiver is also connected to the PC to provide mobile position information. The data collected involves signal strengths, bit error rates, interference, or dropped calls, etc., for each geographical location. Post-processing of the data is performed by a geographical information system that enables the operator to visualize survey data. For “micro” cell monitoring, this is not feasible since real-time information is needed. In addition, the GPS system usually does not provide coverage inside structures.

In another method described in U.S. Pat. No. 6,088,588 to Osborne, a terminal monitors the operation characteristics of its communication with the network, stores information relating to its performance and transmits this information in response to a condition. The terminal is fixed at a pre-determined location. Therefore, while this method is useful for measuring network performance at specific points, it is not particularly useful for measuring network performance throughout a region because a prohibitive number of fixed terminals are used.

In another method described in U.S. Pat. No. 5,644,623 to Gulledge, an automated quality assessment system for a cellular network is described. A Mobile Quality Measurement system, consisting of a laptop computer, one or more cellular radiotelephones and associated controllers, a navigation subsystem used for gathering positioning information, a control for real-time data collection, and an audio quality measurement subsystem collects data. The navigation subsystem must be capable for providing position via the RS232 port. The system's preferred embodiment is the BOSCH Travelpilot. In addition, a Fixed Quality Measurement system also collects data specific to the progress and audio control for each call at the cellular base station end. At the end of a test time period, the data is transferred to an Office Quality Analysis system, which produces statistical tables and graphs that represent the quality of cellular service provided during the test. Again, this system does not provide real-time information. In addition, the navigation subsystem does not provide accurate enough measurements for a “micro” or “pico” cell environment.

In another method described in U.S. Pat. No. 6,266,514 (Ericsson TEMS) to O'Donnell, the mobile station position update information is provided by the base station control and processing unit. The position information can be calculated by triangulating the mobile station's position from the signal strength measures from at least three base station or the position can be derived from a GPS receiver located in the mobile station receiver. In addition, the positioning determination may be performed by the network and no position data needs to be transmitted over the air interface. This system provides real-time information but the mobile station does not calculate the position information itself, instead it is calculated from the signal strength of the mobile station's transmission. This navigation method does not provide accurate enough measurements for conducting network performance monitoring in all locations, including inside buildings.

When monitoring cellular network performance, especially in “micro” or “pico” cell networks, it is essential that the test operator be able to determine his or her location in order to correlate the cellular system performance (like signal strength or channel interference) with each location. In the macro cell environment, it is well known in the prior art on how to collect position/location information for a test operator who is analyzing a cellular radio telephone system. For instance, a processor can use signal strength measurements from three different base stations in order to triangulate the mobile station's position, which is a very crude estimate. Alternatively, a GPS receiver provides the location of the mobile station receiver. Each of these methods may not be viable at all times, especially indoors, because the device may not be able to receive signal strength measurements from three base stations or the GPS system in some locations.

Therefore, a need exists to be able to monitor cellular radiotelephone networks, including “micro” or “pico” cellular networks, in real-time and also to be able to know the exact location of the test operator in order to correlate the system's operational performance to the location where the test operator took the measurements. Specifically, a need exists for a wireless network monitoring system in which location determinations are not based on the receipt of electromagnteic signals, such as radio or GPS signals.

### BRIEF DESCRIPTION OF THE DRAWINGS

FIG. 1 illustrates a wireless network performance measurement system according to an embodiment of the present invention;

FIG. 2 illustrates a monitoring device 1 according to an embodiment of the present invention;

FIG. 3(a) illustrates a handheld display screen that accepts input from a handheld input device according to an embodiment of the present invention;

FIG. 3(b) illustrates a display device in an upright operational position;

FIG. 3(c) illustrates the use of a cradle device with a display device according to an embodiment of the invention;

FIG. 4 illustrates a display screen showing location information in a map according to an embodiment of the present invention;

FIG. 5 illustrates a display screen showing the location of the test operator in respect to other “macro” cell sites according to an embodiment of the present invention;

FIG. 6 illustrates a display screen showing MBRF (Multi-Band Radio Frequency) scanner-supplied information according to an embodiment of the present invention;

FIG. 7 illustrates a display screen presenting neighbor list information according to an embodiment of the present invention;

FIG. 8 illustrates a display screen presenting Layer 3 messaging information according to an embodiment of the present invention;

FIG. 9 illustrates a display screen presenting information from a baseband scanner according to an embodiment of the present invention;

FIG. 10 illustrates a data flow diagram of the data interpretation device and controller and the inertial module within the navigation module according to an embodiment of the present invention; and

FIG. 11 illustrates a menu screen allowing a selection of replay mode according to an embodiment of the present invention;

### DETAILED DESCRIPTION

Embodiments of the present invention relate to a system and method for collecting and analyzing data related to the performance of a wireless communication network. This wireless network performance management system has superior navigational capabilities over previous systems because the monitoring device is tracked as the monitoring device is moved from location to location so the system knows precisely where the monitoring device is. The wireless network performance management system may collect performance data in the form of a performance characteristics or a plurality of performance characteristics in real-time at each of the locations to allow the performance of the wireless communications network to be mapped for a test geographic area. In addition, the system may be portable with long-lasting battery power. The network performance measurement system of the present invention is not limited to a particular communication protocol, e.g., Time Division Multiple Access (TDMA) and Code Division Multiple Access (CDMA).

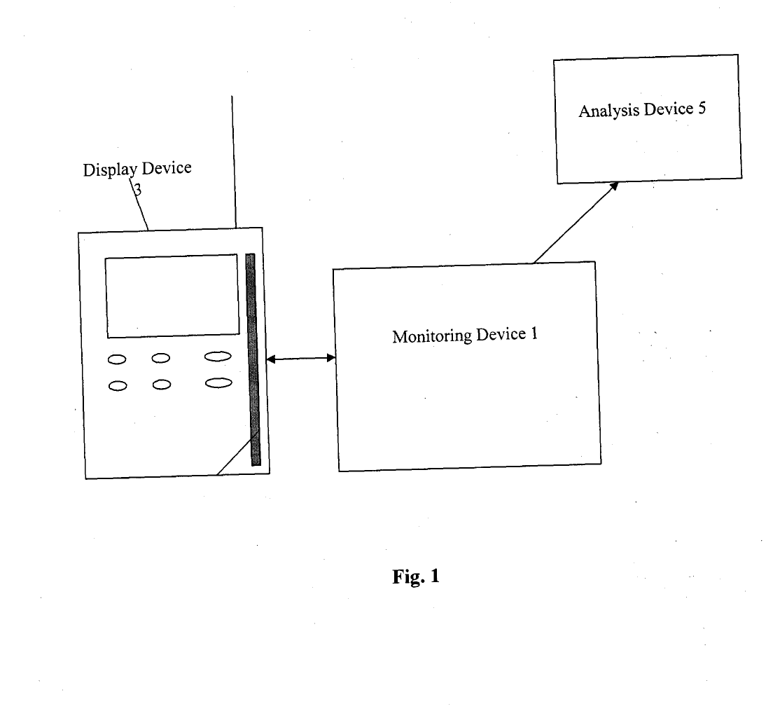

FIG. 1 illustrates a wireless network performance measurement system according to an embodiment of the present invention. The wireless network performance measurement system includes a monitoring device 1, a display device 3, and an analysis device 5.

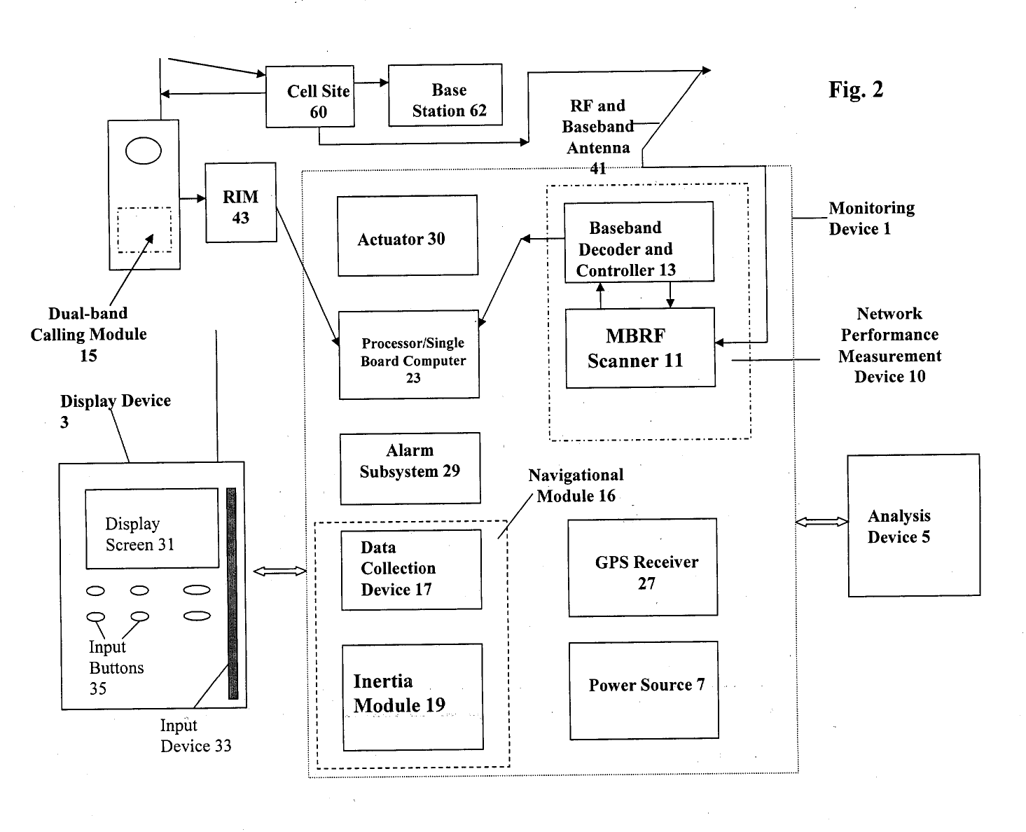

FIG. 2 illustrates a monitoring device 1 according to an embodiment of the present invention. The monitoring device 1 may measure a performance characteristic of a wireless communication network at a plurality of geographic points in a test area. The monitoring device 1 may include at least one power source 7, at least one network performance measurement device 10, (e.g., at least one multi-band radiofrequency (MBRF) scanner 11 and/or a baseband decoder and controller 13), an external data capable multiple band calling module 15, a navigation module 16, including a data controller and interpretation device 17 and an inertia module 19, at least one processor or single-board computer (SBC) 23, a low-level GPS receiver 27, an alarm subsystem 29, an actuator for remote input 30, a radio-frequency (RF) and baseband antenna 41, a radio interface module (RIM) 43. These components are explained in greater detail below.

In an alternative embodiment, the monitoring device 1 may include a plurality of processors or SBCs 23. The number of processors or SBCs 23 may depend on the amount of data the monitoring device 1 is receiving. For example, a plurality of MBRF scanners 11 may be located within the monitoring device 1 and a plurality of SBCs 23 may be utilized to accept and process the data from the plurality of MBRF Scanners 11. Additionally, the Radio Interface Module (RIM) 43 may be transmitting a large amount of data to the SBCs or processors 23, in some embodiments from one multi-band calling module 15 and in other embodiments from multiple multi-band calling modules 15. In alternative embodiments, a plurality of RIMs 43 may be receiving data from a corresponding multi-band calling module 15.

In the embodiment including a plurality of SBCs 23 within the monitoring device 1, the SBCs 23 may communicate with other SBCs 23 via Ethernet or other communication protocols. In alternative embodiments of the present invention, communication between the plurality of SBCs 23 may occur according to Bluetooth™ communication standards.

In an embodiment of the invention, a laptop may be utilized as the monitoring device 1. The laptop may include the actuator 30 and the processor or SBC 23. The laptop may also include the data interpretation device and controller 17. In this embodiment, the MBRF Scanner 11 and the baseband decoder and controller 13 may be located in separate device. The information passed through the MBRF Scanner 11 to the baseband decoder and controller 13 may be transmitted to the laptop via the Universal Serial Bus protocol.

Display Device

FIG. 2 also illustrates a display device 3 that may be used in a wireless network performance measurement system according to an embodiment of the present invention. The display device 3 may receive data from and transmit data to the monitoring device 1. The display device 3 may allow the viewing of the performance characteristic of the wireless communication network that is being measured. The display device 3 may include a display screen 31, an input device 33, and a plurality of data input buttons 35. In an embodiment of the invention, the display device 3 may include a display memory 37 (not shown). The display device 3 may also include a rechargeable power source, such as a battery, or may receive operational power from the monitoring device 1 or another power source. The display device 3 may be activated either by the operator depressing a toggle switch or by the operator actuating some other power control mechanism to direct the monitoring device 1 to send a command to activate the display device 3.

In an embodiment of the present invention, the display device may be a personal digital assistant (PDA). The PDA may include a Liquid Crystal Display (LCD) screen, an input/output port, and a removable storage device. In embodiments of the invention, the PDA may include data buttons. The LCD screen may also have touch screen capabilities. In an embodiment of the present invention, the input/output device may have a Universal Serial Bus (USB)-compatible port. In an embodiment of the invention, the removable storage device may be a memory card device, which allows for both writing and reading to a memory card. In one embodiment of the invention, the input device 33 may allow tactile (touch) input via a stylus.

The monitoring device 1 may bi-directionally communicate with the PDA LCD screen utilizing Low Voltage Device (LVD) signals. The LVD signals may be received by the processor or SBC 23. In an embodiment of the invention utilizing a PDA, the data from the push buttons 35 and the touch screen 31 may be transmitted to the monitoring device 1 utilizing the Universal Serial Bus (USB) protocol. In some embodiments of the present invention, the push button data and the touch screen data may be transmitted utilizing wireless communications. In embodiments of the invention, map data or other graphics data may be transferred from the monitoring device to the PDA, and vice versa, utilizing the memory card device, e.g., a Memory Stick, a Secure Digital, or other similar device.

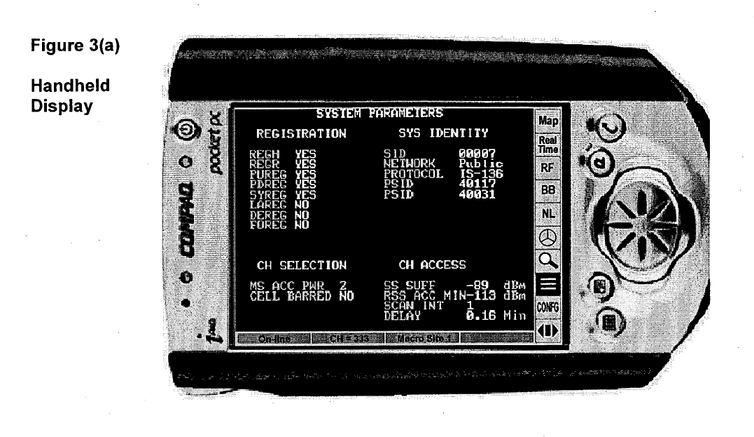

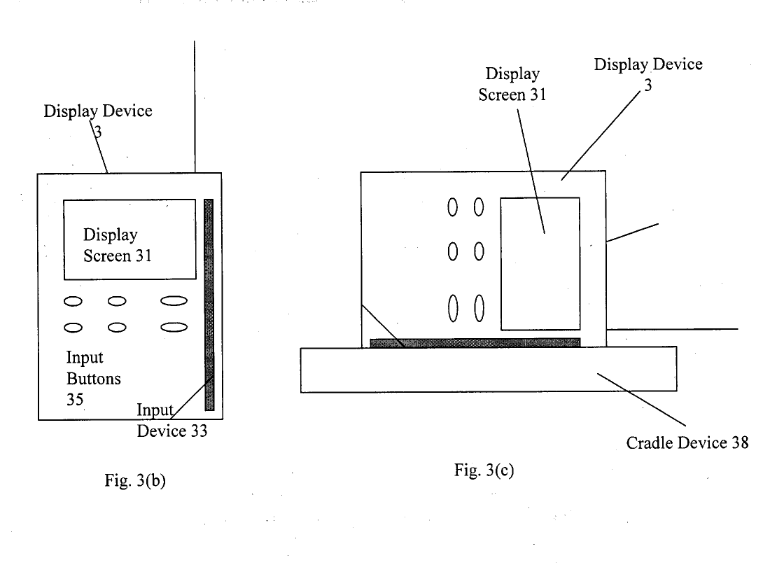

FIG. 3(a) illustrates a hypothetical display screen 3 of the invention that highlights a test operator's input options. As illustrated in FIG. 3, the operator may use the input device 33 to select the “Map,” “Real Time,” “RF,” “BB,” “NL,” “Macro Map,” “Zoom,” or “Configuration” indicators on the display screen 31.

Alternatively, the test operator may interact with the display device 3 by utilizing the data input buttons 35. In one embodiment of the invention, a carrying strap may be attached to the display device 3 to allow a test operator to easily grasp the display device 3. In this embodiment, some of the data input buttons 35 may be located on the opposite side of the display device enclosure to allow for grasping of the display device 3 by either the right or the left hand. In addition, the display device 3 may include display setting options to control the brightness, contract or other display characteristics of the display screen 31. In one embodiment of the present invention, a user may enter waypoints into the display device 3 via the data input buttons, or via a touch screen, i.e., display screen on the display device 3. The waypoints may be utilized to self-correct at least one of the new location of said monitoring device 3 and future locations of said monitoring device 3.

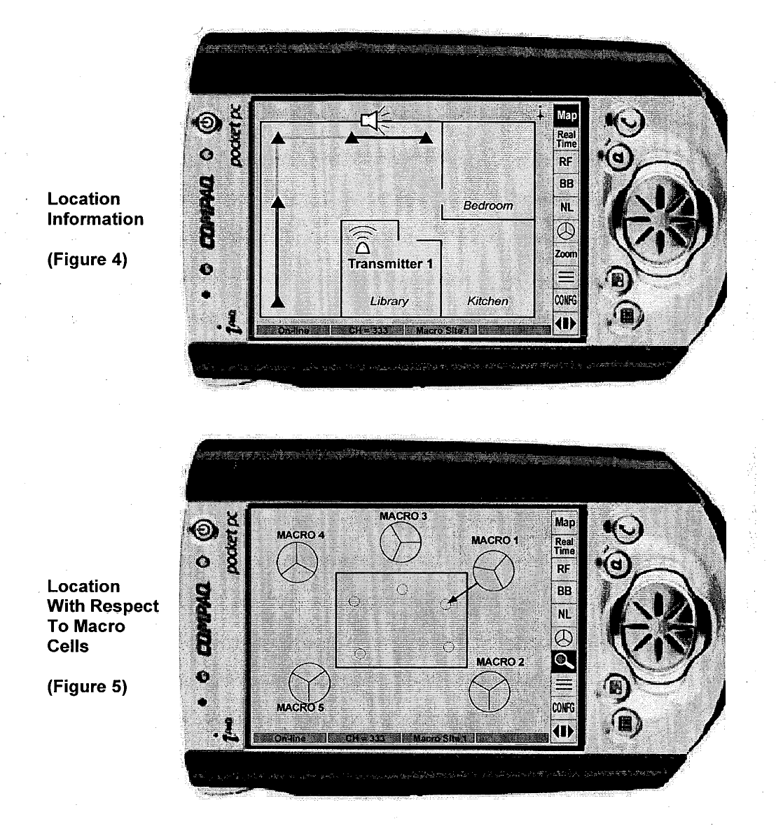

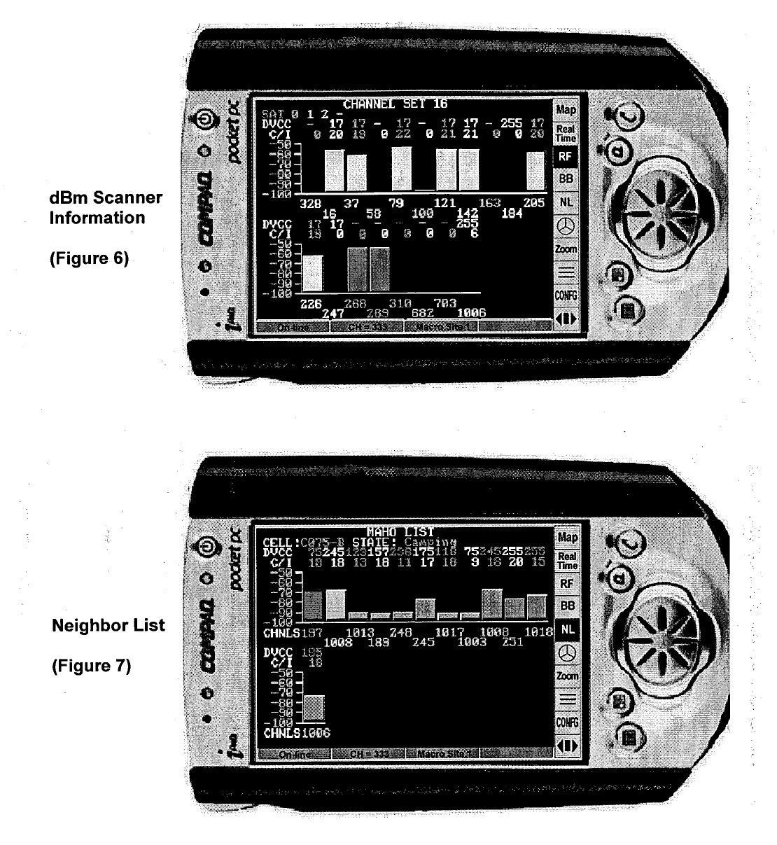

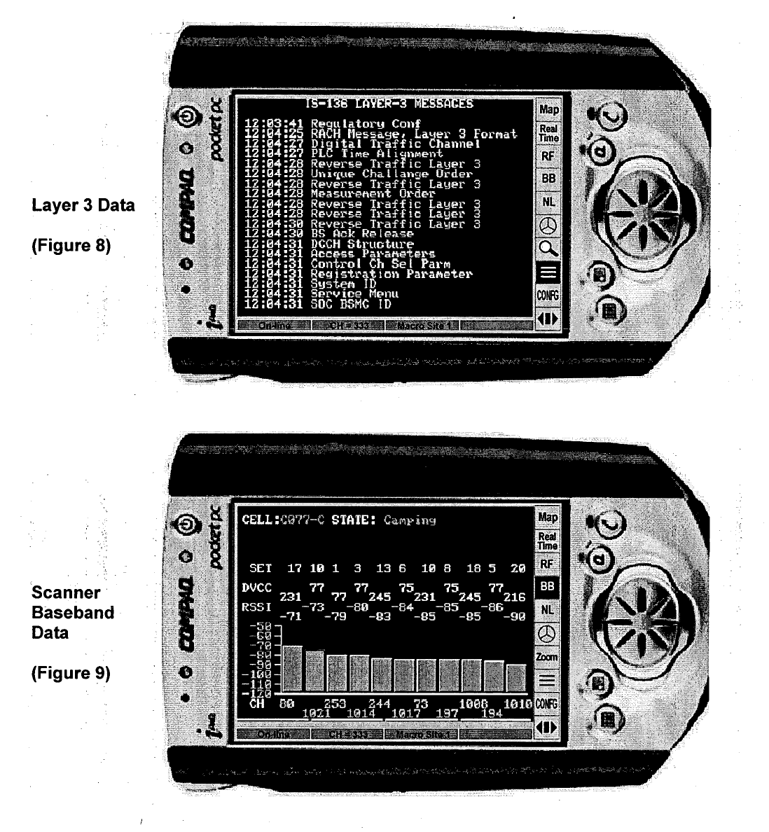

A display device 3 may display different network performance information on the display screen 31. Illustrative, but not limiting, information that may be displayed includes a building map with a trace following the operator's location in the building (FIG. 4), a zoom screen that identifies a cell site where the test operator is located in relation to other neighboring cell sites (FIG. 5), and network performance information like dual-band radiofrequency scanner readings (FIG. 6), neighbor lists (FIG. 7), Layer 3 message transmissions (FIG. 8) and baseband scanner readings (FIG. 9). Layer 3 messages are the controlling messages between the phone and the cellular network.

The display device 3 may present the test operator with an operator-specified combination of information collected by the monitoring device 1 and information stored in the display memory. The test operator may view the graphical representation of the data on the display screen 31. The display device 3 may be initially loaded with application software that allows display and manipulation of charts, maps, floor diagrams, and word processing documents, etc. (e.g., MICROSOFT WORD, and EXCEL), as is well known in the art. In one embodiment of the invention, the application software may be loaded in the display device memory. In an alternative embodiment, the application software may be transmitted from the monitoring device 1 or the analysis device 5. In another alternative embodiment, the application software may be transferred to the display device 3 from a portable memory or storage device (e.g., a memory card) via an display device input/output device (e.g., a memory card reader or a Universal Serial Bus (USB) port).

In one embodiment of the invention, the display device 3 may be initially loaded with display map or floor plan information stored in JPEG, BMP, WMF and TIFF formats. In another embodiment, the display device 3 may receive display map or floor plan information from either the monitoring device 1 or the analysis device 5. In an alternative embodiment of the invention, the display device 3 may receive map information in one format and convert the map information into a displayable format. In another embodiment of the present invention, the monitoring device 1 or the analysis device 5 may convert the map information into a displayable format before transmitting the map information to the display device 3.

After the monitoring device 1 and the display device 3 are initialized, the test operator may request information regarding one of the operational features of the wireless communication system, e.g., the signal strength of the channel the wireless communication device is currently using. The test operator may request this information by any one of the data input methods described above, using the input device 33 or the data input buttons 35. The request is transferred to the monitoring device 1. The monitoring device 1 may gather the requested information and transmit the requested data in the appropriate format to the display device 3, where it is shown on the display screen 31.

In one embodiment of the present invention, the display device 3 may adjust the display screen 31 orientation depending on how the display device 3 is being transported. For example, if the display device 3 is being held by a test operator in the test operator's right hand, the test operator may actuate one of the data input buttons to indicate a “right-hand” viewing display screen 31 orientation (or vice-versa, if the test operator is carrying the display device in the test operator's left hand).

FIGS. 3(b) and 3(c) illustrate the use of a cradle device with a display device according to an embodiment of the invention. The display device 3 may be placed in a cradle device 38 when the test operator may utilize hands-free operation. For example, if the display device 3 is installed in a mobile vehicle that is performing network performance testing, the display device 3 may be installed in a cradle device 38 on the mobile vehicle's dashboard. The display device 3 may be rotated approximately 90 degrees clockwise from its standard operating position, as illustrated in FIG. 3(b), and placed in the cradle device 38, as illustrated in FIG. 3(c) The display device 3 may detect the placement in the cradle device 38 and adjust the display screen 3 orientation accordingly. Illustratively, the placement of a display device 3 in a cradle device 38 may change the display screen orientation from a portrait mode to a landscape mode.

Power Source

The power source 7 may be a replaceable battery pack, a rechargeable battery, a power input terminal configured to receive power from a wall outlet, an AC or DC power supply, or the like. In one embodiment of the present invention, the power source 7 may be integrated with the monitoring device 1. Alternatively, the power source may be physically attached to the monitoring device 1. The power source may be “hot-swappable,” which allows the battery pack to be changed even when the monitoring device 1 is being utilized and powered on. In embodiments of the invention, multiple power sources 7 may be integrated into the monitoring device. Additionally, a power source 7 may be integrated or attached to the display device 3.

The power source 7 may provide power on an emergency basis, i.e., in case of external power failure. In one embodiment, the battery may keep the monitoring device 1 functioning. In an embodiment of the invention, the rechargeable power source may be located inside the monitoring device 1.

Network Measurement Devices (MBRF Scanner)

The monitoring device 1 may include at least one network performance measurement device 10. The network performance measurement device may generate network performance readings of a performance characteristic at the plurality of geographic points. In one embodiment of the present invention, the network measurement device 10 may be a multiple-band, e.g., dual-band or tri-band) radio frequency (MBRF) scanner 11. The network measurement device 10 may also be a baseband scanner 13. It may be possible for a monitoring device 1 to have two or more network performance measurement devices 10, e.g., two MBRF Scanners 11 and a baseband scanner 13. Illustratively, the monitoring device 1 may include one network performance measurement device 10. In alternative embodiments, the monitoring device 1 may include a plurality of network performance measurement devices 10.

The monitoring device 1 may be configured to enable dual-band or tri-band frequency scanning in one of a plurality of transmission technologies. Illustratively, the monitoring device 1 may be configured to allow dual-band radio frequency scanning of a wireless network using either code division multiple access (CDMA) transmission technology or time division multiple access (TDMA) transmission technology. In another embodiment of the present invention, one monitoring device 1 may allow dual-band or tri-band radio frequency scanning of a wireless network utilizing CDMA transmission technology and a second wireless network utilizing TDMA transmission technology, if the second wireless network is operating in the same general geographic location.

The monitoring device 1 may also be configured to enable scanning in one of a plurality of communication standards, communication systems, or communications services within one of the plurality of transmission technologies. For example, if a wireless network utilizes a CDMA transmission technology, the monitoring device 1 may include a MBRF scanner 11 with the ability to scan frequencies (operating frequencies) if the wireless network utilizes the IS-136 standard. Alternatively, the monitoring device 1 may include a MBRF scanner 11 with the ability to scan frequencies and report operating characteristics of the wireless network utilizing the Global System for Mobile Communications (GSM) standard, the Integrated Digital Enhanced Network (IDEN) communications system, the General Packet Radio Service (GPRS) communications service, or the Enhanced Data Rates for GSM Evolution (EDGE) service.

Multi-Band Calling Module (MCBM)

As illustrated in FIG. 2, the multi-band calling module 15 may be external to the monitoring device 1 and may be located inside a wireless device. The multi-band calling module may transmit and/or receive a signal over the wireless communications network at a plurality of geographic points. The multi-band calling module 15 may be interfaced to monitoring device 1 via a Radio Interface Module (RIM) 43. The multi-band calling module 15 may be able to place calls on different frequencies in the wireless network. For example, in a wireless network utilizing TDMA transmission technology and operating under the GSM standard, a dual-band calling module 15 may transmit calls at 900 MHz and 1800 MHz. The multi-band calling module 15 may provide an interface between the wireless device 21 and the monitoring device 1. The MBCM 15 may allow operation in both analog and digital mode along with the ability to place voice and data calls. The MBCM transaction exchange may be initiated by the SBC 23 by way of the RIM 43 or other data interface. The MBCM may communicate its request and transaction to the base station 62, by way of a wireless communications site 60 e.g., cell site. Commands and messages being transmitted between the MBCM 15 and cell site 60 are monitored and logged by the SBC 23.

In one embodiment of the present invention, information from the multi-band calling module may be collected by a network performance antenna, i.e., a RF antenna 41. The MBRF Scanner 11 may receive information from the RF antenna 41. The MBRF scanner 11 may support “follow calling module”, “time shared” or any user-defined mode. In “follow calling” mode, the MBRF scanner 11 may follow the frequency band that the MBCM 21 is utilizing and provide basic Radio Signal Strength Information (RSSI) and baseband decoding. In “time-shared” mode, the MBRF scanner 11 may allocate its total resources to allow the device to follow multiple bands which were selected by the operator. In the user-defined mode, the test operator may select the band and the MBRF scanner 11 may monitor it. In embodiments of the invention, multiple channels may need to be monitored. In one embodiment of the invention, the scan rate of the MBRF scanner 11 may approach 2000 channels per second.

In one embodiment of the invention, the test operator controls the start and end of the test timeframe. As illustrated in FIG. 2, once the test has begun the MBRF scanner 11 may collect information via the RF antenna 41 for the specified channel(s) in a time-correlated fashion. For example, the MBRF scanner 11 may collect information for the specified channels over the operator-specified time frame. The time-correlated MBRF scanner information may be transferred in real-time to the processor 23. At the same time, the navigation module 16, as will be described later, may collect data regarding the location of the monitoring device 1 and/or the multi-band-band calling module 15. The time-correlated location information from the navigation module 16 is combined with the corresponding time-correlated MBRF scanner information in the processor 23. From the processor or SBC 23, the time-correlated MBRF scanner information and the time-correlated navigational module location information may be transferred to temporary storage or may be transferred to the display device 3.

In an embodiment where the time-correlated MBRF scanner information and time-correlated navigation module location information is transferred to the display device 3, the display device 3 may present a real-time graph identifying the operator-selected characteristic of the MBRF scanner 11 for the selected channel(s). For example, the display device 3 may present real-time information on the display screen identifying RSSI for one or more channels selected by the operator. The time-correlated MBRF scanner and location information collected in temporary storage may later be utilized by the analysis device 5 in preparing post-analysis reports.

The information that is collected by the MBRF scanner 11 may include, but is not limited to on-line (i.e., the channel the wireless device is currently using) RSSI, Adjacent Channel RSSI, Neighbor Cell Site List RSSI, user-defined RSSI, bit-error rate (BER) for selected channels, and all layer 3 messages for the appropriate wireless communications standard, e.g., IS-136. The MBRF scanner also collects information on Energy Per Chip (Ec)/Interference or Total Energy (Io), Frame Error Rate (FER), Carrier to Interference (C/I), Carrier to PN, or Carrier to Scrambling Code) in certain transmission modes.

The baseband decoder and controller 13 may receive the information collected and transmitted by the MBRF scanner 11. The information received from the MBRF scanner 11 may be converted from an analog to digital format. The information from the MBRF scanner 11 may also be software filtered. In one embodiment of the invention, the baseband decoder and controller 11 may decode multiple scanning codes and may decode multiple modulated channels for multiple technologies. The baseband decoder and controller 13 may transmit the decoded information, e.g., scanning codes, modulated channel information, etc., to the processor or SBC 23. The processor or SBC 23 may receive the information from the baseband decoder and controller 13 or may transfer this information to a log file. In an alternative embodiment, the information from the baseband decoder and controller 13 may transfer a copy of the decoded information from the baseband decoder and controller 11 directly to a log file before transmitting the information to the processor or SBC 23.

The baseband decoder and controller 13 may identify the source of any external strong signals (“interference”) within the testing location. If the baseband decoder and controller 13 is utilized in a wireless network where data is transmitted via the CDMA transmission method, the baseband decoder and controller may also identify a carrier and a wireless communications site, e.g., a cell site. The test operator or an automatic instruction may control the start and end of the test timeframe.

As illustrated in FIG. 2, once the test has begun, the baseband decoder and controller 13 may collect interference or carrier information through the RF scanner antenna 41 after the information has been transferred though the RF scanner 11. The baseband scanner information may be transferred to the processor 23 from the baseband scanner 13, along with the time in which it was collected. As discussed above in regards to the MBRF scanner 11, the time-correlated location information provided by the navigation module 16 may be combined with the time-correlated baseband decoder and controller information in temporary storage or may be transferred to the display device 3. The time-correlated baseband controller and decoder information 13 and the location information may also transferred from the processor or SBC 23 to both the display device 3 and the analysis device 5. The time-correlated baseband decoder and controller information and the location information transferred to the analysis device 5 may later utilized by the analysis device 5 to generate reports. The time-correlated baseband scanner and location information transferred to the display device 3 may be utilized to present real-time interference or carrier information on the display screen of the display device 3.

Navigation Module

The navigation module 16 may collect a monitoring device heading component and a monitoring device distance component at selected time intervals and may utilize the monitor device heading component and the monitor device distance component to calculate a new monitoring device location within at a plurality of geographic points within a test area. Alternatively, the navigation module 16 may calculate the new monitoring device location only by receiving data utilizing the low-power GPS receiver 27, e.g., in outdoor locations where GPS signals may easily be received. In other embodiments, the navigation module 16 may utilize data received via the GPS receiver 27 along with monitoring device heading component and the monitoring device distance component information to determine the new monitoring device location and calibrate the monitoring device heading component and the monitoring device distance component. A data correlation device 17 in the navigation module 16 may collect raw angular data and raw distance data that becomes the monitoring device heading component and the monitoring device distance component. The inertial monitor 19 may transfer the raw angular data and the raw distance data to a data collection and interpretation device 17 to generate the monitoring device heading component and the monitoring device distance component. The monitoring device heading component and the monitoring device distance component may be correlated with network measurement information from one of the network measurement devices.

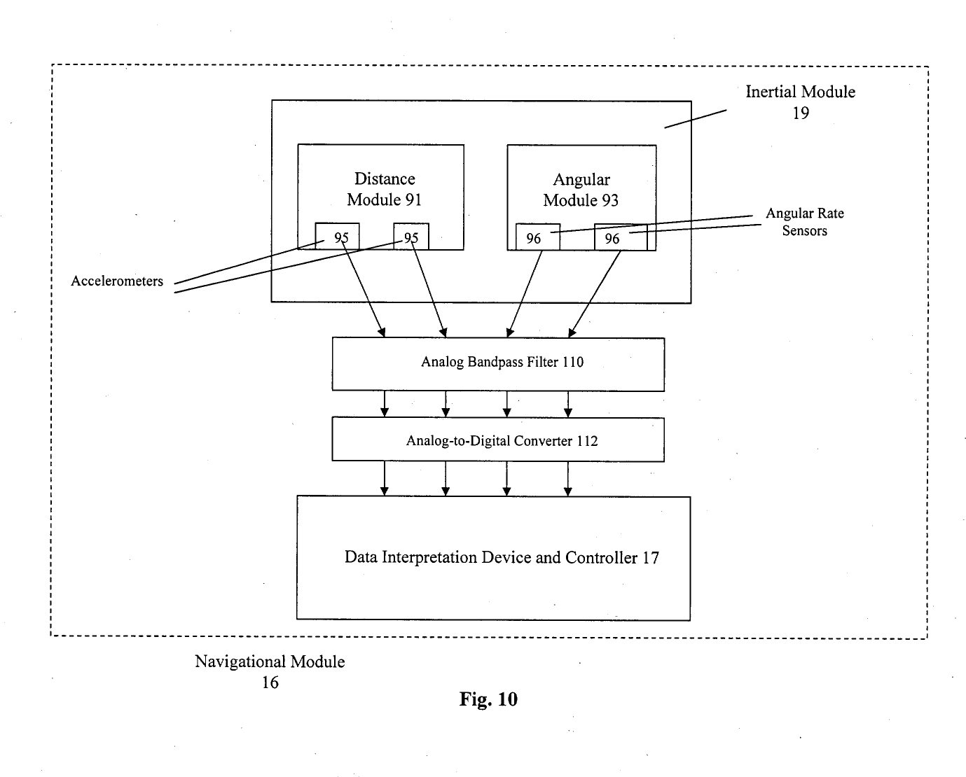

As illustrated in FIG. 10, the inertial device 19 may include a distance module 91, an angular module 93, which both may be located inside the monitoring device 1. The velocity module 91 includes at least one accelerometer 95, which measures vertical acceleration to assist to determine user gait or velocity. The accelerometer may thereby measure the linear velocity of the monitoring device 1 in the direction of travel. The accelerometer 95 may be mounted on or inside the monitoring device 1, the display device 3, or on the operator. In applications of the invention in which the monitoring device 1 is loosely carried by the operator (i.e., where the monitoring device 1 may move relative to the operator), the accelerometer 95 is preferably mounted in the monitoring device 1. The size and weight of the accelerometer 95 and the data transmission rate of the accelerometer may also affect the location of the accelerometer 95.

Preferably, the distance module 91 may include two accelerometers 95, which would allow linear movement to be determined if the monitoring device is carried on its side, i.e., two axis movement. An exemplary embodiment of the invention uses four accelerometers 95 in order to allow operation of the monitoring device in either of two orientations. The orientation may depend on how the operator carries the monitoring device 1. In other words, an operator may be able to turn the monitoring device 1 on its side and still receive readings because two accelerometers 95 may still be able to provide raw distance data for the two-axis of movement of the test operator. In embodiments of the invention, redundant accelerometers 95 may also be included to check the calibration of a main accelerometer or set of accelerometers 95, or to provide backup in case an accelerometer 95 fails. The redundant accelerometer(s) 95 may be positioned off-axis (i.e., not normal to one or more main accelerometer(s).)

The output of the accelerometer or accelerometers 95 may be transmitted through an analog bandpass filter 110. In one embodiment of the invention the analog bandpass 110 filter may be part of a semiconductor device including the accelerometer(s). The output from the analog bandpass filter 110 may be converted into a digital signal in an analog to digital converter 112. In embodiments of the invention, the analog-to-digital converter 112 may be included as part of the semiconductor device that includes the accelerometer(s).

The accelerometer may provide a pulse-width modulated signal to the data interpretation device and controller 17.

The data interpretation device and controller 17 may add the pulsewidth modulated signals corresponding to each accelerometer to create a composite acceleration for each time interval for the monitoring device. The composite acceleration may be passed through a software bandpass filter to remove any DC offset bias and to bandwidth limit the signal to 4 Hz in order to remove any noise or non-gait related components. The data interpretation device and controller 17 may measure the differences or deltas between the composite accelerations for adjoining time intervals to create a delta composite acceleration. The delta composite accelerations may be compared to a threshold value and if the delta composite acceleration exceeds the threshold value, an initial step determination may occur. If a step is determined to be taken, the data interpretation device and controller 17 may determine if a default time period has elapsed since a last final step determination. If the default time period has not elapsed, the initial step determination may be discarded. If the default time period has elapsed, a final step determination may be identified for the time interval.

Illustratively, the data interpretation device and controller 17 may create composite accelerations for time intervals t₁, t₂, t₃, and t₄. The data interpretation device and controller 17 may measure the delta between the composite accelerations for t₁ and t₂, t₂ and t₃, and t₃ and t₄ and create three delta composite accelerations t₁₂, t₂₃, and t₃₄. The delta composite accelerations may be compared to a threshold value tᵥ. If t₂₃ and t₃₄ are greater than tᵥ, an initial step determination may be made for succeeding time intervals t₃ and t₄. Assuming that the previous final step determination occurred at to and the time between to and t₃ is greater than the default time period, and also assuming the time between t₃ and t₄ is less than the default time period, e.g., the default time period being 400 milliseconds, a final step determination may only be made for t₃.

If a final step determination is made for a time interval, the data interpretation device and controller 17 may retrieve a step distance from a gait lookup table and may output the step distance which becomes the monitoring device distance component. The gait lookup table may have standard step distance values or may have custom step distance values established for different operators. The monitoring device distance component for each time interval may be transferred to temporary storage for later combination with the angular module 93 monitoring device heading component. Alternatively, the monitoring device distance component may remain in the data interpretation device and controller for later combination with the angular module 93 monitoring device heading component.

The angular module 93 may provide the monitoring device heading component for each time interval. For example, the angular module 93 may be used to determine the direction the monitoring device may be traveling in or if the monitoring device 1 has made a significant change in direction. If the monitoring device 1 is moving in one direction, say North, and has potential drift from the North normal thereto in the direction of West, the monitoring device 1 may not change its direction until a threshold has been reached. If the monitoring device 1 is turned 90 degrees, a West component may become the main direction of monitoring device travel and the North component may now represent the drift. The angular module 93 may indicate to the system that the axis of rotation has changed and that the monitoring device's 1 location should be calculated based on this new frame of reference. The angular module 93 may be established to have any number of degrees as indicative of a change in the frame of reference, with 90 degrees a common figure.

The angular module 93 may include one or more angular rate sensors 96, as illustrated in FIG. 10. In an embodiment where two angular rate sensors 96 are included in the monitoring device 1, the angular rate sensors 96 may be set at 90 degrees with respect to each other and the angular rate sensors 96 may monitor rotation on two axis so the monitoring device 1 can operate in two different orientations. In one embodiment of the present invention, the angular rate sensor(s) 96 may be piezo-electric vibrating gyroscopes.

The data interpretation device and controller 17 may decide which angular rate sensor 96 output to use by determining which angular rate sensor 96 is closest to being perpindicular to the ground surface based on a combination of initial readings from the angular rate sensor(s) 96 and the accelerometer(s) 95. Alternatively, the operator may specify which accelerometers 95 and angular rate sensors 96 are to be used through an initialization procedure, or may specify the orientation of the monitoring device 1 during such a procedure.

As illustrated in FIG. 10, the output at each time interval from the angular rate sensor(s) may be sent to the data interpretation device and controller 17 to calculate the monitoring device heading component at each time interval. In the data interpretation device and controller 17, the angular rate sensor 96 output at each time interval may be placed in temporary storage. The angular rate sensor 96 output at each time interval may be transferred through an analog bandpass filter 110 to remove DC offset error, to remove Coriolis force, to reduce high frequency spheres and noise, and to provide gain. This filtered angular output at each time interval may be transferred through an Analog-Digital converter (A-D) 112 to create digital angular output.

The digital angular output may be transmitted from the inertial module 19 to the data interpretation module and controller 17 and may calculate the monitoring device heading component at each time interval from the digital angular output. The monitor device heading component at each time interval may be transferred to the temporary storage device where it is combined with the monitoring device distance component at each time interval. Alternatively, the monitoring device heading component may remain in the data interpretation device and controller 17.

In embodiments of the invention utilizing the navigation module 16 to determine the monitoring device 1 position, the monitoring device position may be determined by utilizing the monitoring device distance component (MDDC) and the monitoring device heading component (MDHC). The monitoring device position may be calculated as a latitude-longitude coordinate, as distances from a specified point, or other similar measurements. In order to continuously track the monitoring device as it moves through the test area, a few other values may be established prior to the movement during a calibration process. A calibration gain (CG) for the accelerometers 95 may be defined as the calibration error of the gait's output compared to GPS or user waypoints. A calibration angle (CA) for the angular rate sensor 96 output may be defined as the calibration error of the angular rate sensor's 95 output. The first time the monitoring device 1 is utilized, an initialization routine may run a monitoring device navigation calibration to determine the CG and CA components. An additional component, the middle component (MID), may be provided as the value of the cosine of the average or middle latitude reading. Alternatively, the CG, CA, and MID may each have a default value or a value stored from the last time the monitoring device 1 was utilized. These values may be changed as needed during operation of the monitoring device 1 based on many different inputs.

Monitoring Device Navigation Calibration

In embodiments of the invention utilizing the navigational module 16, known locations, or waypoints may be utilized to assist in determining the monitoring device position. Known initial location information may also be provided to the monitoring device 1 in order to perform the navigation calibration. The data interpretation device and controller 17 may be provided with known initial location information in several ways. In one embodiment, a displayed map of the system test area may be embedded with waypoints that indicate the absolute location, e.g., longitude and latitude coordinates, of portions of the test area to be surveyed. A system map display on the display screen 31 may include waypoint values. The data input device 33 may be utilized to select a waypoint and, thus, the embedded longitude and latitude coordinates of the waypoint. Alternatively, a GPS receiver 27 may be utilized to establish the longitude and latitude of the two locations. However, as noted before, GPS navigation is not as accurate inside buildings and in many cases, is not available indoors. Accordingly, in such embodiments, the absolute location of a waypoint may be established by a GPS receiver 27 during an initialization procedure performed outside of the building in the test area.

In one embodiment of the invention, the navigation calibration may be initiated by utilizing the data input buttons 35 or data input device 33 to indicate that the monitoring device 1 is located at a first known waypoint. The monitoring device 1 may be moved to a second known waypoint. When the monitoring device reaches the second waypoint, the operator may input via the data input buttons 35 or data input device 33 that the second waypoint has been reached. The second waypoint may have a known location, which can be presented in longitude/latitude form or, alternatively as a distance traveled along with an angular component to the distance traveled. As the operator is moving the monitoring device 1 from the first known waypoint to the second known waypoint, the navigational module 16 may be itself calculating the monitoring device location by collecting the monitoring device distance components and the monitoring device heading components at each time interval until the operator has reached the second waypoint. The monitoring device location calculated by the navigational module 16 may be converted to a value that can be compared with the second known waypoint information. The monitoring device location may be compared to the second known waypoint information. The difference in the monitoring device location calculated by the navigational module 16 and the second waypoint may be utilized to determine the calibration gain (CG) and calibration angle (CA).

Real-Time Navigation

After the calibration values, CG and CA, are determined, time-correlated monitoring device locations may be processed more accurately if the navigational module 16 is being utilized to determine the monitoring device 1 locations. The time-correlated monitoring device locations, whether from the navigational module 16, the GPS receiver 26, or a combination of the two, may be combined with the time-correlated network performance characteristic data to obtain a mapping of network performance characteristics throughout the test area.

In embodiments of the invention utilizing the monitoring device heading component and the monitoring device distance component, a new x-axis value, e.g., latitude, may be calculated by adding the value of the (CG*VC,*SINE(CA+AC)) to the old x-axis coordinate. The new y-axis value, e.g., longitude, may be calculated by adding the value of ((CG*VC*COSINE(CA+AC))/MID) to the old y-axis value. For reference, VC may be equal to the monitoring device velocity component and AC may be equal to the monitoring device heading component. The current x-axis and y-axis values become the old x-axis and y-axis values as the new x-axis and y-axis values are calculated. In one embodiment of the invention, new x-axis and y-axis values are calculated every two seconds because the monitoring device velocity components and the monitoring device heading components, or the GPS longitude and latitude coordinates, are measured every two seconds.

A monitoring device 1 may be moved from point to point in a test area collecting network performance information and producing monitoring device locations at selected time intervals. This time-correlated network performance information and time-correlated monitoring device location may be provided to the analysis device 5, either in real-time or on a delayed basis, or in to the display device 3 in real time.

For example, the combined information may be transmitted to the analysis device 5. The MBRF scanner information may be input to the baseband decoder and controller 13 and the information output from the baseband decoder and controller may be correlated to the x-axis and y-axis information output from the data collection device and controller 17 in the navigation module to allow the analysis device 5 provide the necessary information, e.g., a report or graph, to analyze the network's performance for the test area.

Alternatively, or in addition to, the combined monitoring device location information and information output from the baseband decoder and controller 13 may be transmitted to the display device 3. In this embodiment, the information may allow the path traveled by the monitoring device 1 to be displayed on a map of the test area. Different features may be represented by variations in line thickness, color, intensity, and/or symbology.

Later Operation

In an embodiment of the present invention utilizing the navigational module 16, once the device has been calibrated, the monitoring device 1 may utilize a configuration file to provide the necessary values of last x-axis, last y-axis, MID, CA, and CG to calculate the monitoring device location. The monitoring device 1 may create the configuration file when the navigational module 16 is exited, i.e., when the navigation module 16 is no longer being utilized to provide the monitoring device location information. This may be extremely helpful when a test is stopped at a certain location at the end of a day or work period, and then resumed at the exact same location during the next work period. Alternatively, the monitoring device 1 may create the configuration file periodically during utilization of the navigation module 16, e.g., to protect against hardware failures.

The configuration file values can also be used when no GPS data or map waypoints previously are provided to the test operator. The configuration file may assist in providing an initial starting point so that a default blank screen can be used. The user then can correct the direction using user-input waypoints. Illustratively, the operator may measure out waypoints at a known distance and direction from the initial starting point and mark these waypoints both in the physical test area or the displayed map.

Remote Actuator Input

The actuator 30 may allow remote input/operation of the monitoring device 1. In an embodiment of the invention, a monitoring device 1 may include a camera and a transceiver to send picture data to a remote operator. The operator may interface with the monitoring device 1 and control the camera and transceiver through the actuator 30. The monitoring device 1 may be mounted on some type of remotely-controlled vehicle in order to navigate in the test area. The use of the actuator 30 may be useful in remote or uninhabitable environments.

In another embodiment of the present invention, the actuator 30 may be activated either mechanically, e.g., by pressing or depressing a button or flipping a switch, electrically, i.e., by an electric signal sent through the processor in the monitoring device by a remote device, or by entering a given geographic location based on the current longitude and latitude. Once the actuator 30 is activated, the wireless network performance measurement system may start monitoring the operating characteristics of the wireless network by utilizing the monitoring device 1. In other words, once the actuator 30 is activated, the actuator 30 may send signals to a power source 7 in the monitoring device 1 to indicate to begin to start receiving measurements and transmitting information. For example, when the actuator 30 is activated, the actuator 30 sends out a signal to various components of the wireless network performance management system, e.g., the navigation module 16, the network measurement devices 10, the power source 7, etc., indicating that these components should begin operation. In one embodiment of the present invention, an activated actuator 30 may send a signal to the power source 7 that power should be provided to the wireless network performance measurement system, i.e, the monitoring device 1, the display device 3, and the analysis device 5.

In one embodiment of the present invention, one or a plurality of vehicles may be traveling in a geographic area in order to map the operating characteristics for the wireless network in the geographic area. This may be referred to as a vehicle-based wireless communications network measurement system. The one or the plurality of vehicles may each include, within the vehicle, a wireless network performance measurement system. A driver in each of the vehicles may mechanically activate the actuator 30, a central test operator may electrically activate the actuator 30 to allow for remote operation, or the vehicles may automatically activate the actuator 30 when entering a remote geographical area that was predesignated for actuator 30 activation, i.e., by pre-loading longitude and latitude coordinates identifying coordinates for actuator 30 activation. Because the wireless network performance measurement systems may not have operators or display devices, the network performance measurement systems gather time-correlated wireless network operational information and time-correlated vehicle location information and transfers this to a centralized processing device utilizing wireless communication technologies. Alternatively, the information may be transferred via a portable or removable magnetic recording medium, such as a floppy disk, a removable hard disk drive, an optical disk, a R/W optical disk, a memory stick, or a wireless modem utilizing Bluetooth or IEEE 802.11 protocols.

The processing device may be a server, the analysis device 5, or any other device capable of receiving and storing digital or analog information (data). The processing device may receive the time-correlated wireless network operation information and the time-correlated monitoring device(s) location information and store the information in a storage device. In one embodiment of the invention, the information may be stored in a database located on the processing device. The utilization of a database may allow reports to be generated from the information, such as benchmark reports and optimization programs. The reports may be generated by a user running a database retrieval program on the processing device. Alternatively, the reports may be automatically generated based on parameters input to the database retrieval program running on the processing device.

In an embodiment of the invention, a user may be remote to the processing device and may communicate with the processing device via a communications network, such as an Internet. In such an embodiment, the user may login into the database retrieval program on the processing device and run the necessary or selected reports. In an alternative embodiment, the user may download information from the database on the processing device and post-process the information to meet the user's specific needs. For example, the information may be downloaded from the database into a user's client computing device, and the user may incorporate the newly downloaded information into a report showing current and historical data. The reports could be based on geographical locations, cell site's time of day, etc., or based on result parameter such as No Service, Dropped Call, or Poor MOS scores.

Replay Mode

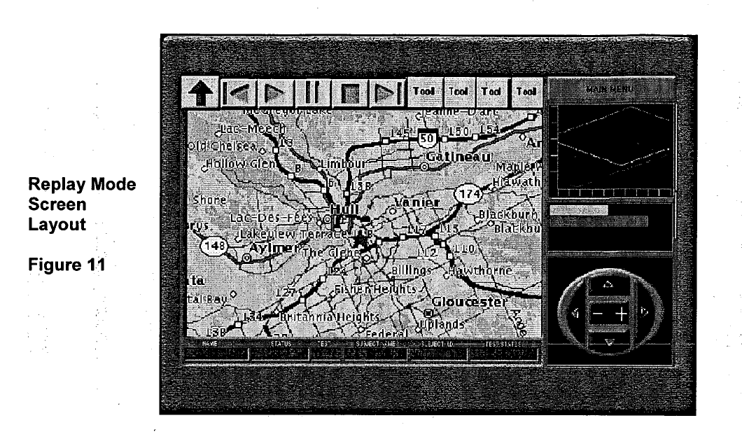

The display device 3 may be utilized to replay previously stored operational characteristics of the wireless network. In one embodiment of the invention, the display device 3 may include a menu option to allow the selecting of a “replay mode,” i.e., the replay of operation characteristics of the wireless network. As illustrated in FIG. 11, a test operator may physically or electrically select the menu option via a touch screen, a data input button, or an electronic stylus to activate a replay mode. The replay mode may include functionality for play, forward, record, stop, and pause buttons to allow the replaying the previously stored data. The display device 3 may include memory for storing recently displayed data and if the replay mode is selected, the data may be retrieved from the display memory to send to the display screen of the display device 3. Alternatively, the data may be stored in a replay storage module on the monitoring device 1, and the display device 3 may need to initiate a request to retrieve the data from the replay storage module on the monitoring device 1. The monitoring device 1 may provide the display device 3 with the requested data. The test operator may select the timeframe desired for the replay mode, e.g., last 5 or last 30 seconds.

Expert Mode

The wireless network performance monitoring system may include “expert mode” functionality. In this context, “expert mode” capability may include identifying possible wireless network interference or signal strength problems in real-time. In one embodiment of the present invention, pre-existing interference or signal strength data may be input into the wireless network performance monitoring system via the display device 3 or the monitoring device 1. For example, propagation modeling information may be input into the wireless network performance monitoring system 1 via a fixed, and portable storage device, such as a floppy disk, removable hard drive, memory card device (e.g., memory stick). The propagation modeling data may identify the source of and location of interference signals for an identified geographic area, which may correspond to the test area.

If the wireless network performance monitoring system is utilizing the “expert mode” capabilities and is operating within a geographic area which has propagation modeling data, the wireless network performance monitoring system may be able to utilize the propagation modeling data to analyze why the interference on a specific channel is so large. For example, the test operator may be measuring signal strength on three channels at a position B, which is identified by A longitude and A latitude. The propagation modeling data input into the wireless network performance monitoring system may identify that a strong interference signal at X frequency exists at the position identified by A longitude and A latitude. If the signal strength of a channel falls below a certain threshold at this position, the wireless network performance management system may search the propagation modeling data to determine if a known operating characteristic of the wireless network, e.g., interference, is present at location B. Because the propagation modeling data identifies that a problem may exist, an error message may be displayed on the display device 3 identifying that the possible reason the signal strength is below the threshold at location B, may be transmitted and displayed on the display screen x of the display device 3.

System Alarms

The monitoring device 1 may also support the generation and playback of real-time alarms to ensure the system is operating correctly. The alarm subsystem 29 may be located within the monitoring device 1 and provide both visible and audible alarm warnings. While not limiting, the alarm subsystem 29 may include basic alarms for “health functions” such as calling module alarms, memory overflow alarms and battery life alarms. In embodiments of the inventions, users maybe allowed to define their own alarms. The alarm may include an alarm subsystem processor, memory, audible and/or visible alarms. A sample of the alarms available in the alarm subsystem 29 may include:

Handoff alarm—an alarm may occur when a call is transferred from one voice channel to another. In this case, the dual-band calling module 15 may indicate this condition has occurred and transmits a signal to the alarm subsystem to turn the alarm, either visibly or audibly, on and/or off.

Low Signal alarm—an alarm may occur when the measured RSSI level is below a threshold RSSI level. The MBRF scanner 11 may transmit a triggering signal to the alarm subsystem 29.

BER alarm—an alarm may occur when the measured bit error rate is above a specified threshold. The MBRF scanner 11 or baseband scanner may transmit a triggering signal to the alarm subsystem 29.

Busy, Dropped Call, Roaming, or No Service alarm—If the wireless device experiences one of these conditions, an alarm may occur. The dual-band calling module 15 may indicate this condition has occurred and transmits a triggering signal to the alarm subsystem 29 to turn the alarm, either visibly or audibly, on.

Battery Alarm—an alarm may occur shortly before a battery must be recharged. The power source 7 may transmit a triggering signal to the alarm subsystem 29 to turn on the alarm when the battery is low.

Memory Limit—an alarm may occur when the system has reached a system memory limit. The processor 23 may transmit a triggering signal to the alarm subsystem 29 to turn on the alarm when the memory threshold is reached.

Analysis Device

The information from the monitoring device 1 may be transferred to the analysis device 5. Alternatively, the information from the monitoring device 1 may be transferred to a storage computing device (not shown), and the analysis device 5 may retrieve the data from the storage computing device. In one embodiment, the analysis device 5 is a personal computer or laptop computer that accepts removable storage devices as peripherals. In an alternative embodiment, the analysis device 5 may be an embedded computing device in the monitoring device. If the analysis device 5 does not accept removable storage devices as peripherals, then the monitoring device 1 may transfer information directly, via line communication or wireless communication technologies to the analysis device 5. One such embodiment would be the transfer of information via a Bluetooth system. Another embodiment could be the transfer of data utilizing an RS232, parallel interface, 802.11 or portable storage device (e.g., a floppy disk or a memory card) between the monitoring device input/output module 26 and the analysis device 5.

The information transferred from the data collection device 1 may be imported into the analysis device 5 and used to analyze network performance. The analysis device 5 may be loaded with analysis software to accept the data from the monitoring device 1 and display the operation characteristics of the tested wireless communications network. In one embodiment, a software program named workBENCH from Comarco Wireless Technologies may accept wireless network performance information from 8 different wireless networks and generate easy-to-understand plots of network performance. workBench may be used to create histograms, charts, graphs, plots and maps correlating network performance, time, and location within the test area.

The analysis device 5 may assist building management in determining the optimal location of servers, cell sites and transmitters within a building and for each building tenant. By utilizing the network performance information from the monitoring device 1, the analysis device 5 may be able to assist in identifying areas where the wireless network coverage is inadequate or non-existent. Once these areas are identified, the building management may address the situation by installing or moving network hardware to provide coverage in the identified areas. The analysis device 5 may also be useful in interpolating the network performance information from the monitoring device 1 for areas where the test operator was not able to gather network performance information from.

In an embodiment of the present invention, the analysis device 5 may be able to display the results of the test, if a display device 3 is not utilized. In this embodiment, the analysis device 5 imports both the building bit map and collected performance data into its memory. The analysis device 5 also has the capability of importing and orienting the collected data onto the building map to be displayed on the analysis device monitor.

In addition, the analysis device 5 is also loaded with replay software for displaying the real-time performance characteristics of the cellular radiotelephone network especially when the test operator does not utilize the display device 3. The time-correlated monitoring device location and the time-correlated network measurement information from the monitoring device 1 are input to the replay software and the replay software may provide a display of the test results on the monitor of the analysis device 5.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are intended to be embraced therein.

What is claimed is:

1. A monitoring device to measure a performance characteristic of a wireless communications network at a plurality of geographic points in a test area, comprising:
a multi-band calling module that at least one of transmits and receives a signal over said wireless communications network at the plurality of geographic points;
a network performance measurement device to generate network performance readings of the performance characteristic at the plurality of geographic points; and
a navigation module to calculate, based on accelerometer output and angular rate readings, a new location of said monitoring device at each of the plurality of geographic points.

2. The monitoring device of claim 1, wherein said navigation module includes a first accelerometer and a first angular rate sensor.

3. The monitoring device of claim 2, wherein said navigation module further includes a second accelerometer and a second angular rate sensor

4. The monitoring device of claim 3, wherein said navigation module includes a third accelerometer and a third angular rate sensor.

5. The monitoring device of claim 1, wherein the navigation module further includes a Global Positioning System (GPS) receiver.

6. The monitoring device of claim 5, wherein a GPS satellite assists said navigation module in determining the new location of said monitoring device.

7. The monitoring device of claim 1, wherein the navigation module calculates the new location of said monitoring device in real-time.

8. The monitoring device of claim 1, wherein the navigation module self-corrects the new location of said monitoring device.

9. The monitoring device of claim 1, further including a power source, said power source selected from one of a replaceable battery pack, a rechargeable battery, a power input terminal, an AC power supply, and a DC power supply.

10. The monitoring device of claim 1, wherein the network performance measurement device is at least one of a multi-band radio frequency scanner and a baseband decoder and controller.

11. The monitoring device of claim 1, further including an actuator to allow remote operation of the monitoring device.

12. The monitoring device of claim 1, further including an alarm subsystem to notify a test operator that a specific condition has occurred.

13. The monitoring device of claim 1, further including a display device to view the performance characteristic of the wireless communication network and to provide input to the monitoring device.

14. The monitoring device of claim 13, wherein the navigation module includes a second accelerometer and a second angular rate sensor.

15. The monitoring device of claim 14, wherein the navigation module further includes a third accelerometer and a third angular rate sensor.

16. The monitoring device of claim 13, wherein the navigation module further includes a Global Positioning Satellite (GPS) receiver.

17. The monitoring device of claim 13, wherein the navigation module calculates the new location of said monitoring device in real-time.

18. The monitoring device of claim 13, wherein the navigation module self-corrects the new location of said monitoring device.

19. The monitoring device of claim 18, wherein waypoints are utilized to self-correct at least one of the new location of said monitoring device and future locations of said monitoring device.

20. The monitoring device of claim 19, wherein the waypoints are input via the display device.

21. The monitoring device of claim 13, wherein the display device is pre-loaded with map or floor-plan information.

22 The monitoring device of claim 13, wherein the display device is coupled to a cradle and the display device modifies screen orientation based on coupling to the cradle.

23. The monitoring device of claim 13, wherein waypoints placed on pre-loaded maps are used to vector scale the new location of the monitoring device.

24. The monitoring device of claim 13, wherein the display device allows operation of a replay mode to view a previously stored operational characteristic of the network.

25. The monitoring device of claim 13, wherein the monitoring device utilizes an expert mode to identify possible wireless network interference and signal strength problems in real-time.

26. The monitoring device of claim 13, wherein the display device is a personal digital assistant (PDA).

27. The monitoring device of claim 13, wherein the monitoring device includes a plurality of single board computers (SBCs).

28. The monitoring device of claim 27, wherein the plurality of SBCs communicate with each other via at least one of an Ethernet protocol, a Bluetooth protocol, or a wireless communication protocol.

29. The monitoring device of claim 13, further including a laptop.

30. The monitoring device of claim 29, wherein the laptop includes an actuator and at least one single board computer.

31. The monitoring device of claim 30, wherein the laptop further includes a data interpretation device and controller.

32. A vehicle-based wireless communications network measurement system, comprising:
at least one monitoring device to measure a performance characteristic of the wireless communications network at a plurality of geographic points in a test area, including
a multi-band calling module that at least one of transmits and receives a signal over a wireless communications network at a plurality of geographic points,
a network performance measurement device to generate network performance readings of the performance characteristic at a plurality of geographic points, and
a navigation module to calculate, based on accelerometer output and angular rate readings, a new location of said monitoring device at each of the plurality of geographic points, and
at least one vehicle to transport the at least one monitoring device to the plurality of geographic points in the test area.

33. The vehicle-based wireless network monitoring system of claim 32, wherein the at least one vehicle is a human-operated motor vehicle.

34. The vehicle-based wireless network monitoring system of claim 32, wherein the at least one vehicle is remote-operated motor vehicle.

35. A method of measuring a performance characteristic of a wireless communications network at a plurality of geographic points, comprising:
at least one of transmitting and receiving a signal over the wireless communications network at the plurality of geographic points;
generating network performance readings of the performance characteristic at the plurality of geographic points; and
calculating a new location of a monitoring device based on accelerometer output and angular rate readings at each of the plurality of geographic points.

36. The method of claim 35, further including displaying the new location of the monitoring device at each of the plurality of geographic points on a display device.

37. The method of claim 35, further including self-correcting said new location of the monitoring device at each geographic point by utilizing at least one of waypoints or a Global Positioning System (GPS) receiver.

38. The method of claim 35, wherein at least one of transmitting and receiving the signal, generating the network performance readings, and calculating the new location are operated remotely, by utilizing an actuator.

39. The method of claim 35, further including transferring the new location of the monitoring device and the network performance readings at each of the plurality of geographic points to an analysis device.

40. The method of claim 35, further including transferring the new location of the monitoring device and the network performance readings at each of the plurality of geographic points to at least one of a server, a monitoring device storage device, a monitoring device random access memory, and a portable memory device.

41. The method of claim 35, further including replaying the network performance readings for a specified subset of the plurality of geographic points.

42. The method of claim 35, further including identifying possible wireless network interference and signal strength problems in real-time.

43. The method of claim 35, further including generating and playing an alarm if the monitoring device is not operating properly.

44. A program code storage device, comprising:
a machine-readable storage medium; and
machine-readable program code, stored on the machine-readable storage medium, having instructions to
at least one of transmit and receive a signal over a wireless communications network at a plurality of geographic points,
generate network performance readings of a performance characteristic at the plurality of geographic points, and
calculate a new location of a monitoring device based on accelerometer output and angular rate readings at each of the plurality of geographic points.

45. The program code storage device of claim 44, further including instructions to display on a display device the new location of the monitoring device at each of the plurality of geographic points.

46. The program code storage device of claim 44, further including instructions to transfer the new location of the monitoring device and the network performance readings at each of the plurality of geographic points to an analysis device.

47. The program code storage device of claim 44, further including instructions to transfer the new location of the monitoring device and to transfer the network performance readings at each of the plurality of geographic points to at least one of a server, a monitoring device storage device, a monitoring device random access memory, and a portable memory device.

48. The program code storage device of claim 44, further including instructions to replay the network performance readings for a specified subset of the plurality of geographic points.
